(19) United States
(12) Patent Application Publication
(10) Pub. No.: US 2025/0267356 A1
(43) Pub. Date: Aug. 21, 2025

(54) ELECTRONIC DEVICE AND CONTROL METHOD FOR ELECTRONIC DEVICE

(71) Applicant: CANON KABUSHIKI KAISHA, Tokyo (JP)

(72) Inventor: TAKUMA FUJIWARA, Kanagawa (JP)

(21) Appl. No.: 19/048,058

(22) Filed: Feb. 7, 2025

(30) Foreign Application Priority Data
Feb. 15, 2024 (JP) 2024-021146

(51) Int. Cl. H04N 23/63; H04N 23/53

(52) U.S. Cl. CPC H04N 23/631; H04N 23/53; H04N 23/635

(57) ABSTRACT

An electronic device acquires a captured image. The electronic device performs control such that a plurality of acquired captured images are arranged and displayed in order of image capturing in a plurality of image display regions. In a case where a delimiting image, which indicates delimitation, in order of image capturing, is included in the acquired images, the electronic device performs control so as to display a display item, which indicates delimitation, in a region outside the plurality of image display regions, without displaying the delimiting image in the plurality of image display regions.

### BACKGROUND OF THE INVENTION

### Field of the Invention

The present invention relates to an electronic device and a control method for the electronic device.

### Description of the Related Art

In a case of displaying a list of a plurality of images, acquired by consecutive shooting by a camera, many thumbnails having similar patterns are disposed. Therefore, a user cannot easily determine images belonging to a same group among the plurality of images.

Japanese Patent Application Publication No. 2008-141270 discloses a technique to acquire meaningful delimitation between captured image groups, and dispose a delimiting image at the delimiting position, so that the user can visually determine the delimitation more easily.

In the technique according to Japanese Patent Application Publication No. 2008-141270, the user can determine the delimiting positions among a plurality of images by viewing a display device.

With this technique however, the delimiting image is displayed in the display region of the captured images, hence the number of captured images displayed decreases by the number of delimiting images displayed.

### SUMMARY OF THE INVENTION

With the foregoing in view, it is an object of the present invention to provide a technique to suppress a decrease of the number of images displayed in a list, and still allow the user to recognize the delimiting positions.

An aspect of the present invention is an electronic device, including: an acquisition unit configured to acquire a captured image; and a control unit configured to perform control such that a plurality of captured images acquired by the acquisition unit are arranged and displayed in order of image capturing in a plurality of image display regions, wherein in a case where a delimiting image, which indicates a delimitation in order of image capturing, is included in the images acquired by the acquisition unit, the control unit performs control so as to display a display item, which indicates delimitation, in a region outside the plurality of image display regions, without displaying the delimiting image in the plurality of image display regions.

An aspect of the present invention is a control method for an electronic device, the method including: an acquisition step of acquiring a captured image; and a control step of performing control such that a plurality of captured images acquired in the acquisition step are arranged and displayed in order of image capturing in a plurality of image display regions, wherein in a case where a delimiting image, which indicates a delimitation in order of image capturing, is included in the images acquired in the acquisition step, control is performed in the control step so as to display a display item, which indicates delimitation, in a region outside the plurality of image display regions, without displaying the delimiting image in the plurality of image display regions.

Further features of the present invention will become apparent from the following description of exemplary embodiments with reference to the attached drawings.

### BRIEF DESCRIPTION OF THE DRAWINGS

FIG. 1 is a system block diagram of a digital camera according to Embodiment 1;

FIG. 2 is an external view of the digital camera according to Embodiment 1;

FIGS. 3A to 3H indicate screens according to Embodiment 1;

FIG. 4 is a flow chart of processing to record a delimiting image according to Embodiment 1;

FIG. 5 is a flow chart of reproducing an image according to Embodiment 1;

FIG. 6 is a flow chart of processing to determine a display target and a display region according to Embodiment 1;

FIGS. 7A to 7D are diagrams for describing control of a reproduction screen according to Embodiment 1;

FIGS. 8A to 8D are diagrams for describing control of a reproduction screen according to Embodiment 1; and

FIGS. 9A to 9F are diagrams for describing the reproduction screens according to Embodiment 1.

### DESCRIPTION OF THE EMBODIMENTS

Embodiments of the present invention will now be described with reference to the accompanying drawings.

### Embodiment 1

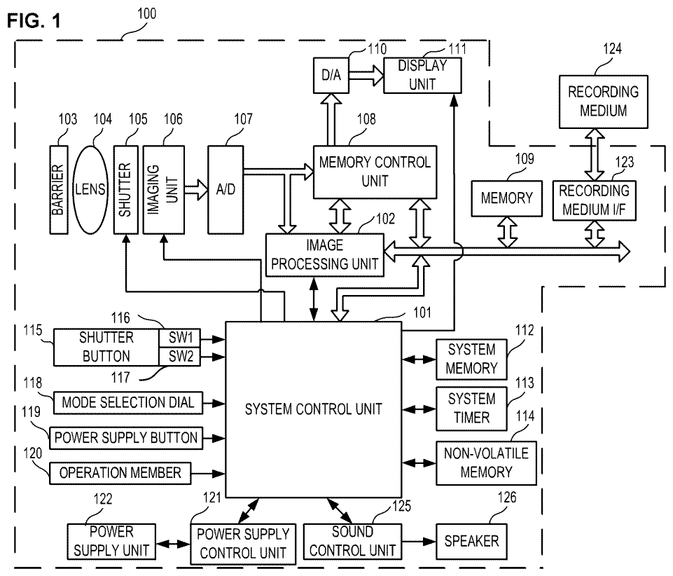

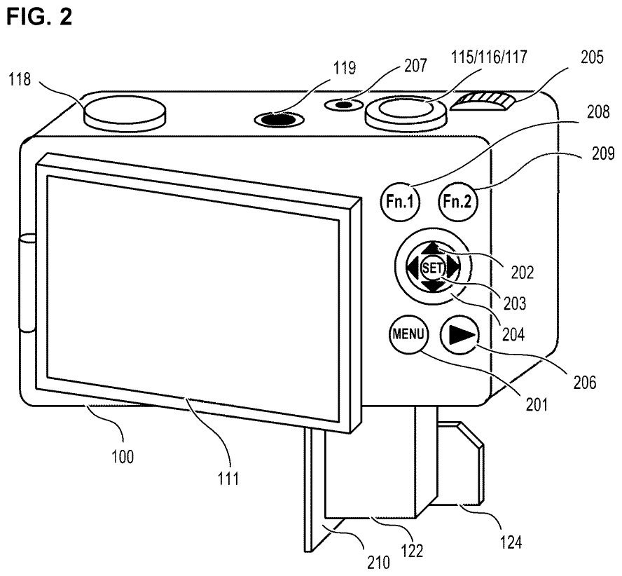

FIG. 1 is a block diagram depicting an example of a system configuration of a digital camera 100 (imaging apparatus) according to Embodiment 1. FIG. 2 is an external view of the digital camera 100. Instead of the digital camera 100, Embodiment 1 may be applied to any electronic device (e.g. smartphone, personal computer) having an imaging unit.

An image capturing lens 104 is a lens group including a zoom lens and a focus lens. A shutter 105 is a shutter including an aperture function. An imaging unit 106 is an image pickup element constituted of elements (e.g. CCD, CMOS element) to convert an optical image into electric signals. The imaging unit 106 acquires an image captured by imaging a real space. An A/D converter 107 converts analog signals into digital signals. The A/D converter 107 is used for converting analog signals, which are outputted from the imaging unit 106, into digital signals. A barrier 103 covers an imaging system (including the image capturing lens 104) of the digital camera 100. Thereby the barrier 103 prevents contamination of and damage to the imaging system (including the image capturing lens 104, the shutter 105, and the imaging unit 106).

An image processing unit 102 performs predetermined pixel interpolation, resize processing (e.g. reduction), or color conversion processing on the data from the A/D converter 107, or the data from a memory control unit 108. The image processing unit 102 also performs predetermined arithmetic processing using the captured image data. Based on the acquired arithmetic operation result, a system control unit 101 performs exposure control and the distance measurement control. Thereby a through-the-lens (TTL) type auto focus (AF) processing, auto exposure (AE) processing, or pre-flash emission (EF) processing is performed. Further, the image processing unit 102 performs predetermined arithmetic processing using the captured image data, and performs TTL type auto white balance (AWB) processing using the acquired arithmetic operation result.

The output data from the A/D converter 107 is directly written to a memory 109 by the “image processing unit 102 and a memory control unit 108”, or by the “memory control unit 108” alone. The memory 109 stores image data, which is acquired by the imaging unit 106, and then is converted into digital data by the A/D converter 107. The memory 109 stores image data displayed on a display unit 111. The memory 109 has a storage capacity that is sufficient for storing a predetermined number of still images, or a predetermined duration of moving images and sounds.

The memory 109 is also a memory for image display (video memory). A D/A converter 110 converts the data for image display, stored in the memory 109, into analog signals, and supplies the analog signals to the display unit 111. When the image data for display, written in the memory 109, is supplied to the display unit 111 via the D/A converter 110 like this, the image based on the image data is displayed on the display unit 111.

The display unit 111 performs display in accordance with the analog signals supplied from the D/A converter 110 on such a display as an LCD. The digital signals, which were A/D-converted once by the A/D converter 107 and were stored in the memory 109, are converted into analog signals by the D/A converter 110. Further, by sequentially display images based on the transferred signals, the display unit 111 can function as an electronic view finder, and display through-images (hereafter a through-image is called a “live view image”).

A non-volatile memory 114 is an electrically erasable/recordable memory. For the non-volatile memory 114, an EEPROM, for example, is used. In the non-volatile memory 114, constants, programs and the like, for operating the system control unit 101, are stored. The “programs” here refers to the programs for executing the processing steps of various flow charts, described later in this embodiment.

The system control unit 101 controls the digital camera 100 in general. The system control unit 101 implements each later mentioned processing of this embodiment, by executing the above mentioned programs recorded in the non-volatile memory 114. For a system memory 112, a RAM is used. In the system memory 112, constants and variables for operating the system control unit 101, programs (programs read from the non-volatile memory 114), and the like are developed. The system control unit 101 also performs display control by controlling the memory 109, the D/A converter 110, the display unit 111 and the like. A system timer 113 is a timer unit that measures the time used for various controls, and measures the time of an internal clock.

A shutter button 115, a mode selection dial 118, a power supply button 119 and an operation unit 120 are operation units to input various operation instructions to the system control unit 101 respectively.

The mode selection dial 118 switches the operation mode of the system control unit 101 to one of: a still image recording mode, a moving image recording mode, and a detail mode included in each operation mode.

A first shutter switch 116 turns ON in mid-operation of the shutter button 115, which is disposed on the digital camera 100, that is, in the half-depressed state (image capturing preparation instruction), and generates a first shutter switch signal SW1. In response to the generation of the first shutter switch signal SW1, such an operation as auto focus (AF) processing, auto exposure (AE) processing, auto white balance (AWB) processing, or pre-flash emission (EF) processing is started

A second shutter switch 117 turns ON when operation of the shutter button 115 is completed, that is, in the fully-depressed state (image capturing instruction), and generates a second shutter switch signal SW2. In response to the generation of the second shutter switch signal SW2, the system control unit 101 starts a series of operations of image capturing processing (processing from reading signals from the imaging unit 106 to writing image data to the recording medium 124).

A power supply control unit 121 includes a battery detection circuit, a DC-DC converter, a switch circuit (circuit to switch a block to be energized) and the like. The power supply control unit 121 detects the state of the power supply button 119, whether or not a battery is installed, a type of battery, and the residual amount of battery charge. The power supply control unit 121 also controls the DC-DC converter based on this detection result and instructions from the system control unit 101. Thereby the power supply control unit 121 supplies the required voltage to each component (including a recording medium 124) for a required period.

A power supply unit 122 includes a primary battery (e.g. alkali battery, lithium battery), a secondary battery (e.g. NiCd battery, NiMH battery, Li battery), an AC adapter and the like. In this embodiment, a case of using a secondary battery for the power supply unit 122 (hereafter called a “battery 122”) will be described.

A recording medium I/F 123 is an interface to connect the recording medium 124 (e.g. memory card, hard disk). The recording medium 124 is such a medium as a memory card, which is used for recording captured images. The recording medium 124 is constituted of a semiconductor memory, a magnetic disk, or the like.

The digital camera 100 can perform notification, such as a warning, by sound. Specifically, a speaker 126 can output a sound generated by a sound control unit 125.

Each operation member of the operation unit 120 operates as a specific functional button. An appropriate function is assigned to each operation member in accordance with the selection from various function icons displayed on the display unit 111. The function button assigned to each member is, for example, an end button, a return button, an image switching button, a jump button, a filter button, and an attribute change button.

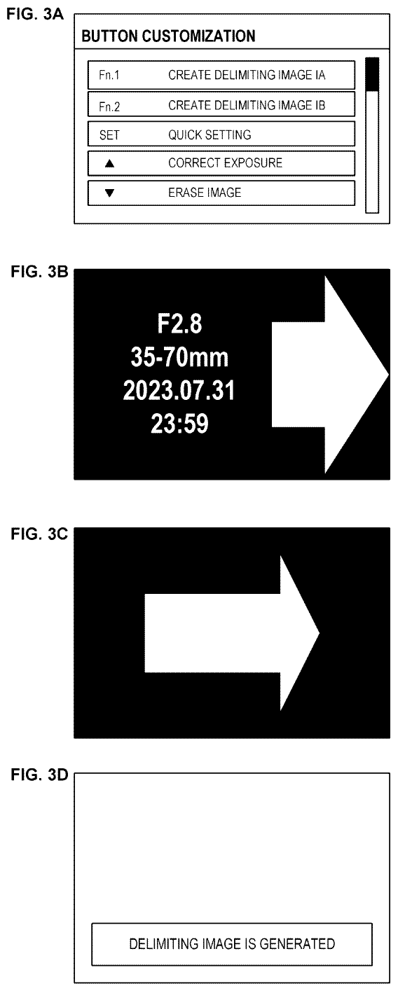

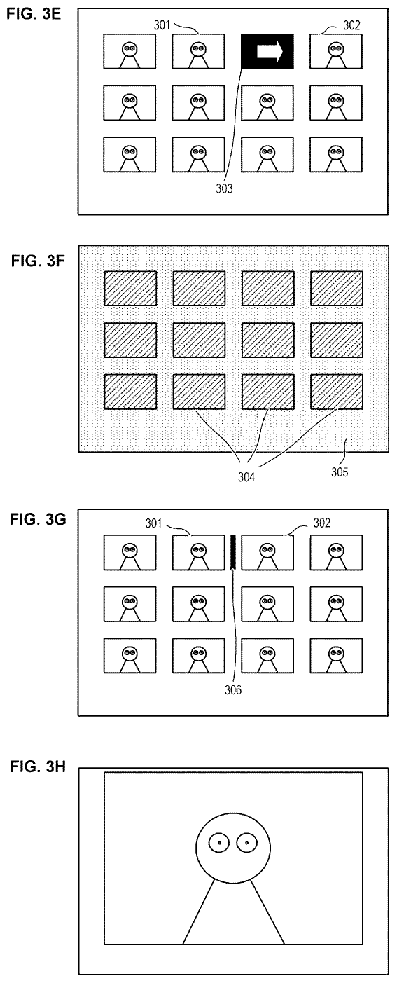

For example, when a menu button 201 in FIG. 2 is pressed, a menu screen, on which various settings can be performed, is displayed on the display unit 111 (see FIG. 3A). The user can perform various settings intuitively while checking the menu screen displayed on the display unit 111, using a cross button 202 (an operation member having buttons in four directions: up, down, left, right) and a SET button 203.

A controller wheel 204 and an electronic dial 205 are rotatable operation members included in the operation unit 120. The controller wheel 204 and the electronic dial 205 are used with the cross button 202 to instruct a selected item, for example. By pressing a reproduction button 206, an image capturing mode or a reproduction mode of the digital camera 100 can be selected. By pressing a moving image recording start button 207, recording of a moving image can be started or stopped

The user can freely assign an arbitrary function to a function button 208 (hereafter called an “Fn1 button 208”) and a function button 209 (hereafter called an “Fn2 button 209”). When a function button is pressed, the digital camera 100 executes the function assigned to this function button.

The battery 122 and the recording medium 124 can be inserted into the digital camera 100 from the bottom face of the digital camera 100. The bottom face of the digital camera 100 can be covered by a cover 210 which can be opened/closed.

An overview of generating a delimiting image, which indicates a delimitation between two captured images, will be described next. A function to generate the delimiting image can be assigned to an operation member on a menu screen, as indicated in FIG. 3A. The delimiting image is an image to indicate a delimitation of a plurality of captured images when a list of the plurality of captured images (images of a real space captured by the imaging unit 106) is displayed (list reproduction), as indicated in FIGS. 3B and 3C.

When a button, to which the function to generate the delimiting image is assigned, is pressed in the image capturing standby state immediately after performing consecutive image capturing, the delimiting image is generated as an image next to the series of captured images. The generated delimiting image is recorded in the recording medium 124 as a file.

If the delimiting image is used, the user can easily confirm the delimitation of a plurality of consecutively captured images, even if a plurality of thumbnails having a similar pattern lineup in the list display (on the displayed reproduction screen), as illustrated in FIG. 3E. The system control unit 101 may also generate a specific delimiting image at a timing when a predetermined change occurred, and records this delimiting image in the recording medium 124. The specific delimiting image here is preferably a delimiting image which is different from both the delimiting image IA and a delimiting image IB, which will be described later. Then in the list display, the user can more easily recognize images, captured before the timing when the predetermined change occurred. The timing when a predetermined change occurred is a timing when a set value of the digital camera 100 was changed, a timing when a lens was replaced, or a timing when the date was changed, for example.

In Embodiment 1, two types of delimiting images are provided. One of the two delimiting images is called a “delimiting image IA” (see FIG. 3B), and the other is called a “delimiting image IB” (see FIG. 3C). As illustrated in FIG. 3A, the delimiting image IA can be generated by pressing the Fn1 button 208. The delimiting image IB can be generated by pressing the Fn2 button 209.

A file name, conforming to a “predetermined naming rule” the same as a naming rule of captured images, is attached to a delimiting image, and the delimiting image is recorded in the recording medium 124. For the file name, a unique number may be attached in order of image capturing (in order of generation; in order of recording). In other words, the predetermined naming rule may be any naming rule with which files (images) can be rearranged in order of generation based on the file names. For example, the design rule for a camera file system (DCF) may be used for the naming rule of still images. The file name may also be a number which indicates a date and time of image capturing (year+month+day+hour+minute+second). In this case, if a file name of a certain image is “20231117025030”, for example, it is known that this image was captured (generated) on Nov. 17, 2023, at 2:50:30. Even in a case where a delimiting image and a plurality of captured images are sent from the digital camera 100 to a PC, the PC can rearrange the images in order of file numbers, whereby the delimiting image can be displayed at a desired position.

On the reproduction screen, which is a screen on which a plurality of captured images are displayed as a list in order of image capturing times, a plurality of captured images are displayed side-by-side, as illustrated in FIG. 3E. As illustrated in FIG. 3F, the reproduction screen includes a first region 304 (shaded portion in FIG. 3F) where captured images or delimited images are displayed, and a second region 305 (dotted portion in FIG. 3F) which is a region other than the first region 304. The first region 304 is basically a set of a plurality of rectangular regions (except a case of displaying only one image). The plurality of rectangular regions are disposed next to each other at specific intervals, without touching each other. Instead of a rectangular region, a specific form of region, such as a circular region or a polygonal region, may be used. As illustrated in FIG. 3E, if a delimiting image 303 is displayed in the first region 304 in the same manner as the captured images 301 and 302, for example, a number of captured images that can be displayed on the reproduction screen decreases by a number of delimiting images displayed.

On the other hand, as illustrated in FIG. 3G, the digital camera 100 may display a delimiting item 306, which is a display item to indicate delimitation, in the second region 305, instead of displaying the delimiting image in the first region 304. In this case, the digital camera 100 can clearly indicate the position of delimitation without decreasing a number of captured images that can be displayed on the reproduction screen.

The delimiting item 306 is displayed in the second region 305 between the first regions 304, where the images before and after the delimiting image in order of image capturing are displayed. If the image before or after the delimiting image is displayed at an end column of the plurality of first regions 304 in a matrix, the delimiting item 306 is displayed in the second region 305 on the front side (left side) of the first region 304, where the image after the delimiting image in order of image capturing is displayed. The delimiting item 306 may also be displayed in the second region 305 on the rear side (right side) of the first region 304, where the image before the delimiting image in order of image capturing is displayed.

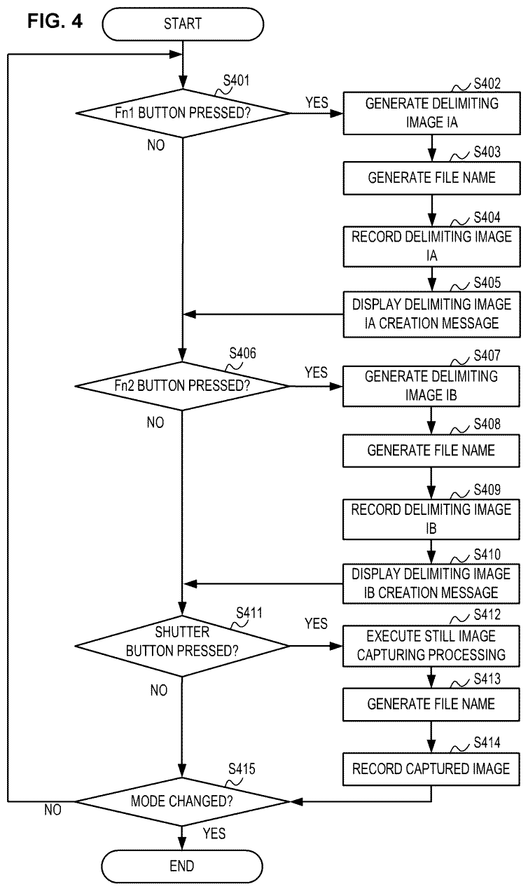

The processing of recording delimiting images according to Embodiment 1 will now be described with reference to the flow chart in FIG. 4. When the digital camera 100 is set to the image capturing mode, the state of the digital camera 100 changes to the image capturing standby state. In the image capturing standby state, the processing of the flow chart in FIG. 4 is cyclically executed.

In step S401, the system control unit 101 determines whether the Fn1 button 208 is pressed. Processing advances to step S402 if it is determined that the Fn1 button 208 is pressed. Processing advances to step S406 if it is determined that the Fn1 button 208 is not pressed.

In step S402, the system control unit 101 generates the delimiting image IA.

In step S403, the system control unit 101 generates a file name of the delimiting image IA in accordance with a predetermined naming rule. The predetermined naming rule here is a naming rule the same as a naming rule of the file name of a still image in step S413, which will be described later.

In step S404, the system control unit 101 records the delimiting image IA attached with the generated file name in the recording medium 124.

In step S405, the system control unit 101 displays a message to notify that the delimiting image IA was generated (recorded) on the display unit 111, as indicated in FIG. 3D.

In step S406, the system control unit 101 determines whether the Fn2 button 209 is pressed. Processing advances to step S407 if it is determined that the Fn2 button 209 is pressed. Processing advances to step S411 if it is determined that the Fn2 button 209 is not pressed.

Processing in steps S407 to S410 is processing to generate and record the delimiting image IB. The processing in steps S407 to S410 is the same processing as the processing in steps S402 to S405, which is processing to generate and record the delimiting image IA, hence description thereof will be omitted.

In step S411, the system control unit 101 determines whether the shutter button 115 is pressed (second shutter switch 117 is pressed). Processing advances to step S412 if it is determined that the shutter button 115 is pressed. Processing advances to step S415 if it is determined that the shutter button 115 is not pressed.

In step S412, the system control unit 101 controls the imaging unit 106 and executes image capturing. Thereby the system control unit 101 performs processing to generate a still image (captured image).

In step S413, the system control unit 101 generates a file name of the generated still image (captured image) in accordance with a predetermined naming rule.

In step S414, the system control unit 101 records the still image (captured image) attached with the generated file name in the recording medium 124.

In step S415, the system control unit 101 determines whether the operation mode is changed from the image capturing mode. The processing of this flow chart ends if it is determined that the operation mode is changed from the image capturing mode. Processing advances to step S401 if it is determined that the operation mode is not changed from the image capturing mode.

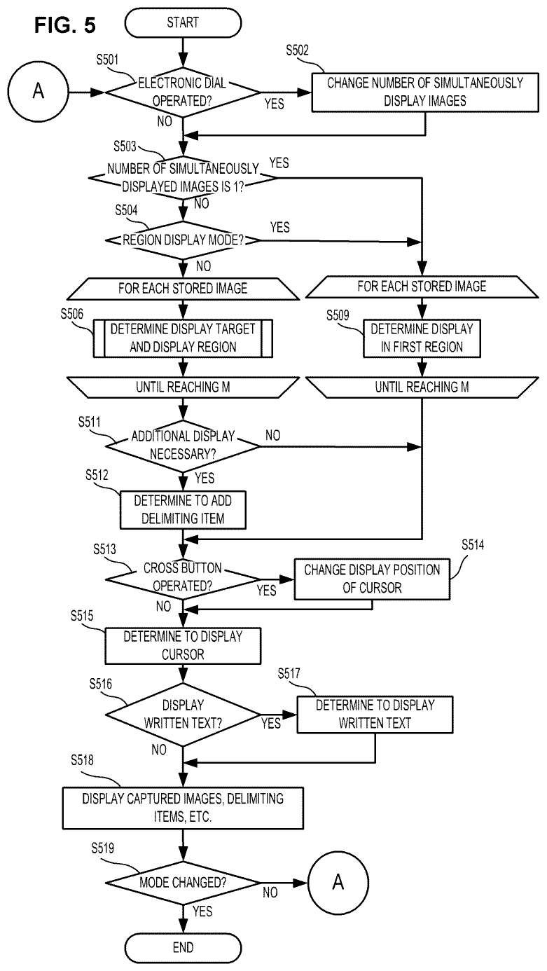

FIG. 5 is a flow chart of reproduction processing (list display) of captured images and delimiting images by the digital camera 100 according to this embodiment. In a case where the digital camera 100 is in the image reproduction mode, the system control unit 101 executes the processing in the flow chart in FIG. 5 periodically.

In step S501, the system control unit 101 determines whether the electronic dial 205 is operated by the user. Processing advances to step S502 if it is determined that the electronic dial 205 is operated. Processing advances to S503 if it is determined that the electronic dial 205 is not operated.

In step S502, the system control unit 101 changes (determines) a number of images displayed in the first region 304 on the reproduction screen (hereafter called “a number of simultaneously displayed images”) in accordance with the operation amount of the electronic dial 205 (rotation amount of the electronic dial 205). In the following, a number of simultaneously displayed images is expressed as “M number of images”. FIG. 3H is a reproduction screen in a case where the M number of images (a number of simultaneously displayed images) is 1, and only 1 image is displayed in the first region 304. FIG. 3E is a reproduction screen in a case where the M number of images is 12, and 12 images are displayed in the first region 304. Based on the number of simultaneously displayed images determined in step S502, the system control unit 101 sets (generates) the first region 304, which includes rectangular regions for the M number of images.

In step S503, the system control unit 101 determines whether the M number of images (a number of simultaneously displayed images) is 1. Processing advances to step S509 if it is determined that the M number of images is 1. Processing advances to step S504 if it is determined that the M number of images is not 1.

In step S504, the system control unit 101 determines whether a mode to display all the delimiting images in the first region 304 (hereafter called “region display mode”) is set. Processing advances to step S509 if it is determined that the region display mode is set. Processing advances to step S506 if it is determined that the region display mode is not set.

The processing in step S506 is executed for each image stored in the recording medium 124 until specific conditions are satisfied. Here in the recording medium 124, N number (N≥M) of captured images have been stored in the processing of the flow chart in FIG. 4. Further, in the recording medium 124, at least one of the delimiting image IA and the delimiting image IB have been stored. The system control unit 101 repeats “performing processing in step S506 for one image stored in the recording medium 124, and then performing processing in step S506 for the next one image”.

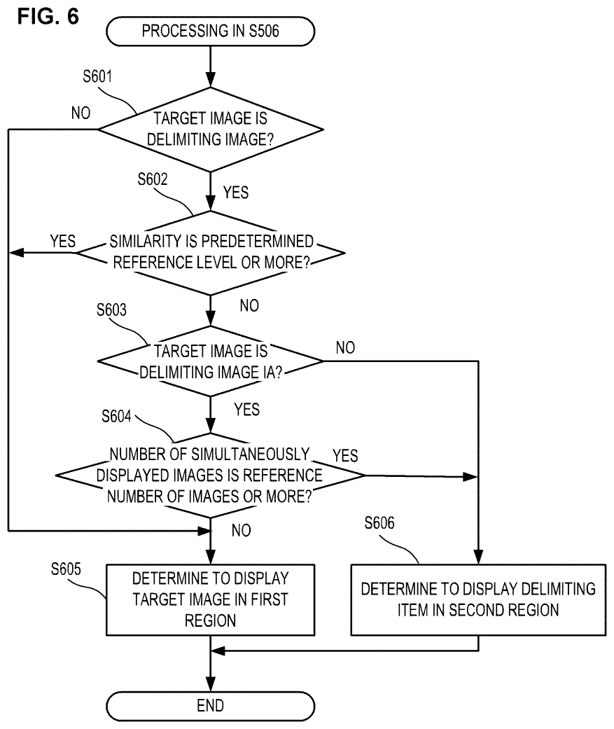

The processing in step S506, which will be described later with reference to FIG. 6, is processing to determine a “display target and display region” corresponding to a processing target image (hereafter called “target image”). The first target image, for which the system control unit 101 performs the processing in step S506, may be an image specified by a cursor (described later), or may be an image of which generation timing is closest to the present. After performing the processing in step S506 for the first target image, the system control unit 101 executes the processing in step S506 for the image group, of which generation timings are older than the above target image, in order from the image of which generation timing is closest to the present.

In step S506, the system control unit 50 determines whether the target image is displayed in the first region 304. If a number of images, which are determined to be displayed in the first region 304, reaches the M number of images (a number of simultaneously display images), processing advances to step S511. Then the system control unit 50 selects (determines) M number of images to be displayed in order in the first region 304, out of at least one image (N number of captured images and at least one delimiting image) stored in the recording medium 124.

### Step S506

A specific processing for one target image in step S506 will be described with reference to a flow chart in FIG. 6.

In step S601, the system control unit 101 determines whether the target image is a delimiting image. Processing advances to step S602 if it is determined that the target image is a delimiting image. Processing advances to step S605 if it is determined that the target image is not a delimiting image.

In step S602, the system control unit 101 determines whether the similarity of the image before the target image (hereafter called a “previous image”) and the image after the target image (hereafter called a “subsequent image”) is a predetermined reference level or more. Processing advances to step S605 if it is determined that the similarity of the previous image and the subsequent image is a predetermined reference level or more. Processing advances to step S603 if it is determined that the similarity of the previous image and the subsequent image is less than the predetermined reference level.

For example, in a case where the similarity of the captured image 301 and the captured image 302 is high in FIG. 3G, there is a possibility (risk) that the user may miss the delimiting item 306. However if the system control unit 101 displays the delimiting image 303 in the first region 304, as illustrated in FIG. 3E, instead of displaying the delimiting item 306, the delimitation between the captured image 301 and the captured image 302 becomes clear. Thereby the user is less likely to miss the delimitation. The similarity between a plurality of images may be determined using machine learning. Further, the system control unit 101 may always advance the processing to step S603, without determining the similarity in step S602.

In step S603, the system control unit 101 determines whether the target image is a delimiting image including text (that is, delimiting image IA). Processing advances to step S604 if it is determined that the target image is the delimiting image IA. Processing advances to step S606 if it is determined that the target image is not the delimiting image IA.

In the delimiting image IA, text, indicating information on the setting and the like of the digital camera 100 or the image capturing lens 104 at the image capturing, is written, as illustrated in FIG. 3B. Therefore an advantage of displaying the delimiting image IA in the first region 304 is that, “the user can recognize this information”. In the delimiting image IB, on the other hand, this information is not written. Therefore even if the delimiting image IB is replaced with a delimiting item which only indicates the delimiting position, the user is not affected very much by the replacement.

In step S604, the system control unit 101 determines whether the M number of images (a number of simultaneously displayed images) is a reference number of images (predetermined number of images) or more. Processing advances to step S606 if it is determined that the M number of images is the reference number of images or more. Processing advances to step S605 if the M number of images is less than the reference number of images.

In the case where the number of simultaneously displayed images is high, each image is displayed in a small size. If the size of the image is smaller than a predetermined size, it is difficult for the user to visually recognize the text of the camera setting or the like in the delimiting image IA, even if the delimiting image IA is displayed in the first region 304. In other words, the benefit of displaying the delimiting image IA in the first region 304 is low, hence in the subsequent step (step S606), the system control unit 101 determines that the delimiting item is displayed instead of the delimiting image IA.

The reference number of images here may be specified by the user in advance, or may be a value in accordance with a physical size of the display screen of the display unit 111. For example, the reference number of images may be a bigger value as the physical size of the display screen of the display unit 111 is larger, since the user can visually recognize the details of each image if the screen is large, even if a number of simultaneously displayed images is high. The reference number of images may be a value in accordance with a relative size of the characters written in the delimiting image IA with respect to the size of the delimiting image IA. The reference number of images may be a smaller value as the relative size of the characters written in the delimiting image IA is smaller, since it becomes more difficult for the user to recognize the characters as the characters become smaller.

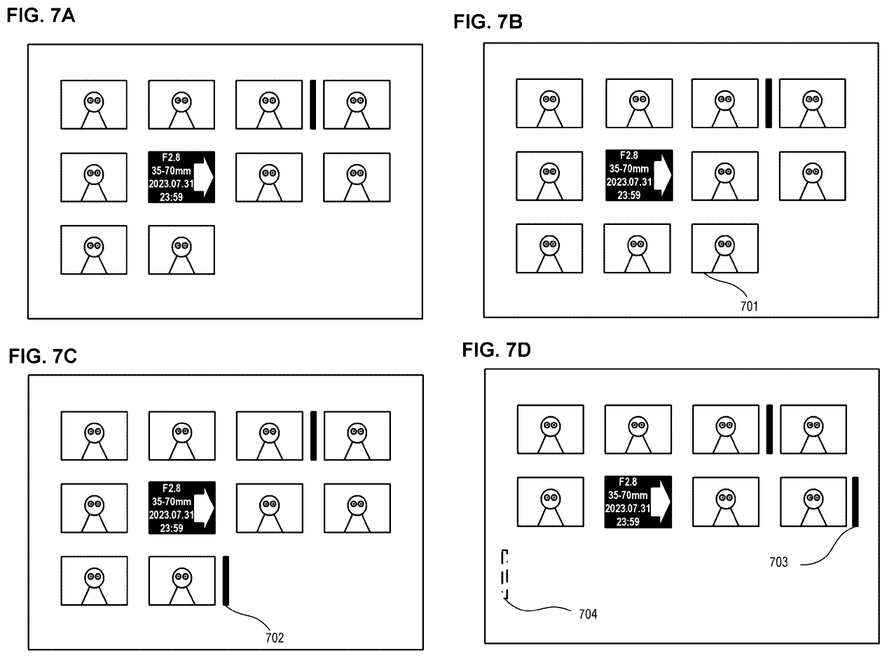

In step S605, the system control unit 101 determines to display the target image in the first region 304. For example, if the system control unit 101 determines to display the target image in step S605 in the state where display of 10 images has been determined, as illustrated in FIG. 7A, an image 701 is added, as illustrated in FIG. 7B.

In step S606, the system control unit 101 determines to display a delimiting item (delimiting item corresponding o the target image) to indicate the delimitation in the second region 305, instead of the target image of the delimiting image. For example, if the system control unit 101 determines to display the delimiting item in step S606 in the state where display of 10 images have been determined, as illustrated in FIG. 7A, a delimiting item 702 is added, as illustrated in FIG. 7C.

In other words, the system control unit 101 disposes the delimiting item at a position between an image of which display is previously determined and the next image, so as to express the delimitation of the captured images. Depending on a number of images of which display is determined just before the processing in step S606, the system control unit 101 may determine to display the delimiting item at both or at one of a position 703 and a position 704 indicated in FIG. 7D.

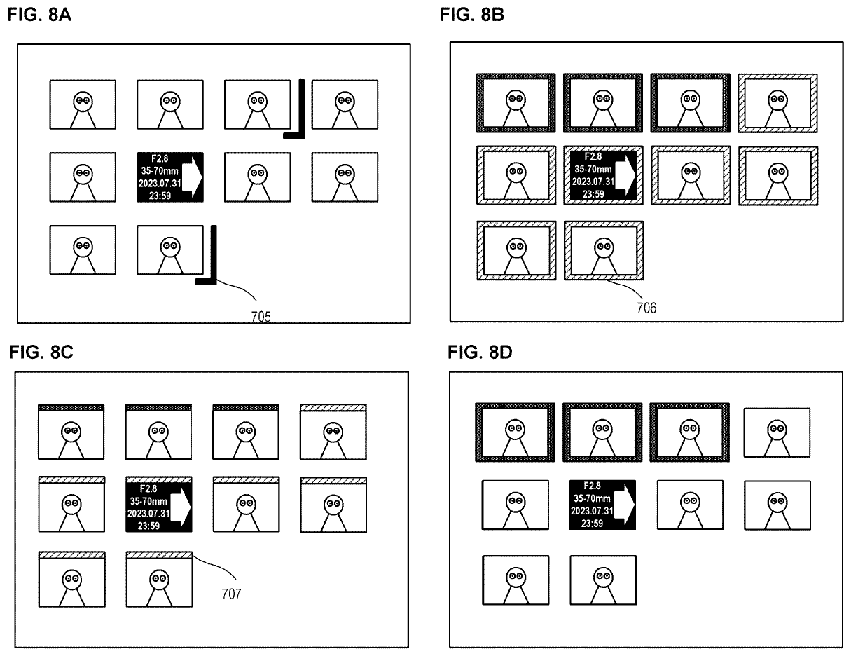

The delimiting item to be displayed may be the delimiting item 702 expressed by a vertical line, as illustrated in FIG. 7C, or may be an L-shaped delimiting item 705, as illustrated in FIG. 8A. Further, the delimiting item to be displayed may be a frame type delimiting item 706 or a bar type delimiting item 707 that trims the image displayed on the first region 304, as illustrated in FIGS. 8B and 8C. In the case where the delimiting item to be displayed is a frame or a bar, the user can visually recognize the delimiting position by color or pattern of the frame or bar. In a case where the reproduction screen to be drawn is as illustrated in FIG. 8D, if display of a new delimiting item 706 is determined in step S606, the delimiting item is added to the “images after the image trimmed by the previous delimiting item”, as illustrated in FIG. 8B.

Description on the flow chart in FIG. 5 will be continued. In step S509, the system control unit 101 determines to display one image, stored in the recording medium 124, in the first region 304. Just like step S506, the system control unit 101 repeats “performing processing in step S509 for one image stored in the recording medium 124, and then performing processing in step S509 for the next image “until specific conditions are satisfied”. “Specific conditions are satisfied” means “a number of images, of which display in the first region 304 is determined, reaches M number of images (a number of simultaneously displayed images)”.

In step S509, the system control unit 101 determines to constantly display the processing target image in the first region 304. Processing advances to step S513 if a number of images, of which display in the first region 304 is determined, reaches M number of images (a number of simultaneously displayed images).

In step S511, the system control unit 101 determines whether display of an additional delimiting item (hereafter called “additional display”) is necessary. Processing advances to step S512 if it is determined that additional display is necessary. Processing advances to step S513 if it is determined that additional display is not necessary.

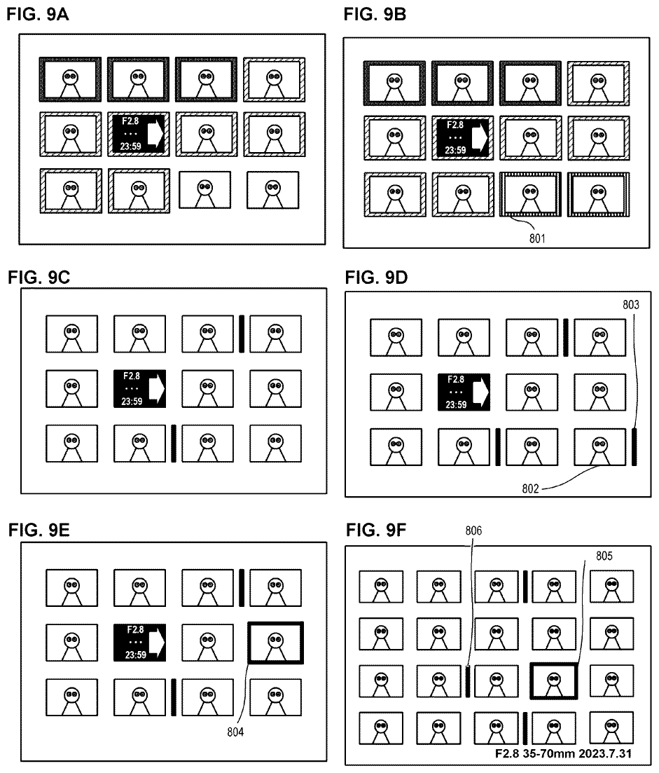

For example, in a case where the reproduction screen to be drawn is the screen in FIG. 9A at the starting point of the processing in step S511, only the lower right two images are not trimmed. Hence the system control unit 101 determines that display of the delimiting items to trim the lower right two images is necessary. This means that the system control unit 101 determines that display of the additional delimiting item 801 is necessary, as illustrated in FIG. 9B, for example. On the other hand, in a case where the delimiting item not a frame type but a bar type, as illustrated in FIG. 7C, the system control unit 101 determines that display of the additional delimiting item is not necessary in step S511. However even in the case where the delimiting item is a bar type, the system control unit 101 may determine that the display of the additional delimiting item 803 is necessary if the image next to the image displayed last (captured image 802 in FIG. 9D) is the delimiting image.

In step S512, the system control unit 101 determines to display the additional delimiting item.

In step S513, the system control unit 101 determines whether the cross button is operated by the user. Processing advances to step S514 if it is determined that the cross button is operated. Processing advances to step S515 if it is determined that the cross button is not operated.

In step S514, the system control unit 101 changes the position of a cursor displayed on the reproduction screen, in accordance with the operation performed with the cross button. The cursor is, for example, a frame surrounding an image displayed in the first region 304, as illustrated in FIG. 9E.

In step S515, the system control unit 101 determines the display of the cursor.

In step S516, the system control unit 101 determines whether a text written in the delimiting image IA (hereafter called “written text”) need be displayed at the edge of the screen. Processing advances to step S517 if it is determined that the written text need be displayed at the edge of the screen. Processing advances to step S518 if it is determined that the written text need not be displayed at the edge of the screen.

For example, in a case where the delimiting image IA is not displayed in the first region 304 as an image, and the delimiting item is displayed in the second region 305 instead of the delimiting image IA, the user cannot visually recognize the written text. In such a case, the system control unit 101 may determine that the written text need be displayed at the edge of the screen (see FIG. 9F).

For example, the system control unit 101 specifies a delimiting image IA of which generation time is newer than the image 805 indicated by the cursor, and of which generation time is closest to the image 805. Then if this delimiting image IA is not displayed in the first region 304 as an image and a delimiting item 806 is displayed instead, the system control unit 101 determines that the written text of the delimiting image IA need be displayed at the edge of the screen. In other words, the system control unit 101 regards an image group delimited by the delimiting item as a group, and determines that the text written in the delimiting image IA, corresponding to the group where the image indicated by the cursor belongs, need be displayed at the edge of the screen. Thereby in a case where the user generates the delimiting image IA every time the date changes, the user can select an image of interest by cursor and visually recognize the generation data and the like of the image in the display at the edge of the screen.

In step S517, the system control unit 101 determines to display the written text at the edge of the reproduction screen.

In step S518, the system control unit 101 actually displays the “image, delimiting item, cursor and text”, of which display was determined in steps S506, S512 and S515, on the reproduction screen (display unit 111).

In step S519, the system control unit 101 determines whether the operation to change mode is performed. Processing of this flow chart ends if it is determined that the operation to change mode is performed (the image reproduction mode ends). Processing advances to step S501 if it is determined that the operation to change mode is not performed.

As described above, in a specific case, the digital camera 100 displays the delimiting item corresponding to the delimiting images, outside the display region of the captured images. Thereby more captured images can be simultaneously displayed, than the case of displaying the delimiting image in the display region of the captured images, while allowing the user to visually recognize the delimitation of the images.

Whereas a case of using two types of delimiting images (delimiting image IA and delimiting image IB) was described above, a number of types of the delimiting images may be 1 or 3 or more.

In the case where only one type of delimiting image is used, the system control unit 101 may always advance the processing to step S604, without performing the determination in step S603. In the case where 3 or more types of delimiting images are used, the system control unit 101 may set levels for the delimiting images, and perform determination in step S603 according to the level. For example, a level is set for each delimiting image depending on the type. Processing advances to step S604 if the level of the target image is a specific level or more. Processing advances to step S606 if the level of the target image is less than the specific level. For example, the system control unit 101 sets (classifies) each delimiting image to any one of level 1, level 2 and level 3, then processing advances to step S604 if the level of the target image is level 2 or higher. Processing advances to step S606 if the level of the target image is level 1.

The present invention is applicable not only to the digital camera 100, but also to a display device which can display a list of captured images. For example, instead of the digital camera 100, a person computer, PDA, portable telephone terminal, portable image viewer, digital photo frame, game machine, electronic book reader, tablet terminal or smartphone may be used. Further, instead of the digital camera 100, a home electronic device, an on-vehicle device, or medical apparatus, including a display, may be used. The digital camera 100 may be an electronic device (display control device) for controlling a display device which can display a list of captured images. In this case, the electronic apparatus may have a configuration other than the display unit 111 of the digital camera 100.

According to the present invention, a decrease in a number of images displayed in a list can be suppressed, and the user is can still recognize the delimiting positions.

Whereas the present invention has been described based on embodiments, the present invention is not limited to these specific embodiments, and various modes in a scope not departing from the spirit of the invention are included in the present invention. A part of each embodiment described above may be combined as required.

In addition, in the above, “when A is equal to or larger than B, the processing proceeds to Step S1, while when A is smaller (lower) than B, the processing proceeds to Step S2” may read “when A is larger (higher) than B, the processing proceeds to Step S1, while when A is equal to or smaller than B, the processing proceeds to Step S2”. To the contrary, “when A is larger (higher) than B, the processing proceeds to Step S1, while when A is equal to or smaller than B, the processing proceeds to Step S2” may read “when A is equal to or larger (higher) than B, the processing proceeds to Step S1, while when A is smaller (lower) than B, the processing proceeds to Step S2”. Thus, unless contradiction occurs, “equal to or larger than A” may read “larger (higher; longer; more) than A”, and “equal to or smaller than A” may read “smaller (lower; shorter; less) than A”. And “larger (higher; longer; more) than A” may read “equal to or larger than A”, and “smaller (lower; shorter; less) than A” may read “equal to or smaller than A”. Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-021146, filed on Feb. 15, 2024, which is hereby incorporated by reference herein in its entirety.

What is claimed is:

1. An electronic device, comprising one or more processors and/or circuitry configured to:
perform acquisition processing to acquire a captured image; and
perform control processing such that a plurality of captured images acquired by the acquisition processing are arranged and displayed in order of image capturing in a plurality of image display regions, wherein
in a case where a delimiting image, which indicates a delimitation in order of image capturing, is included in the images acquired by the acquisition processing, it is controlled in the control processing to display a display item, which indicates delimitation, in a region outside the plurality of image display regions, without displaying the delimiting image in the plurality of image display regions.

2. The electronic device according to claim 1, wherein
it is controlled in the control processing to display the display item between image display regions in which images before and after the delimiting image in order of image capturing are displayed, or on a front side of an image display region in which an image after the delimiting image in order of image capturing is displayed, or on a rear side of an image display region in which an image before delimiting image in order of image capturing sequence is displayed.

3. The electronic device according to claim 1, wherein in the control processing,
in a first case, it is controlled to display the delimiting image without displaying the display item, and
in a second case, it is controlled to display the display item without displaying the delimiting image.

4. The electronic device according to claim 3, wherein
the first case is a case of displaying one image, and
the second case is a case of displaying a plurality of images in the plurality of image display regions.

5. The electronic device according to claim 3, wherein
the first case is a case where a number of the plurality of image display regions is less than a predetermined number, and
a second case is a case where the number of the plurality of image display regions is at least the predetermined number.

6. The electronic device according to claim 5, wherein
the predetermined number is a value in accordance with a physical size of a display surface on which the plurality of image display regions are displayed.

7. The electronic device according to claim 1, wherein
the delimiting image is not a captured image but an image including text.

8. The electronic device according to claim 7, wherein
in a case where the display item is displayed outside the plurality of image display regions, in the control processing, it is controlled to display the text outside the plurality of image display regions.

9. The electronic device according to claim 3, wherein
the second case is a case where the delimiting image is an image which does not include text.

10. The electronic device according to claim 3, the one or more processors and/or circuitry further configured to perform determination processing to determine similarity of two captured images delimited by the delimiting image, wherein
the first case is a case where the similarity determined by the determination processing is higher than a predetermined reference level.

11. The electronic device according to claim 3, wherein
a level is set for the delimiting image, and
the second case is a case where the level of the delimiting image is less than a specific level.

12. The electronic device according to claim 1, wherein
the plurality of image display regions are M number of rectangular regions, each having a predetermined shape and not in contact with one another.

13. The electronic device according to claim 12, wherein
the value of M is changeable by user operation.

14. A control method for an electronic device, the method comprising:
an acquisition step of acquiring a captured image; and
a control step of performing control such that a plurality of captured images acquired in the acquisition step are arranged and displayed in order of image capturing in a plurality of image display regions, wherein
in a case where a delimiting image, which indicates a delimitation in order of image capturing, is included in the images acquired in the acquisition step, control is performed in the control step so as to display a display item, which indicates delimitation, in a region outside the plurality of image display regions, without displaying the delimiting image in the plurality of image display regions.

15. A non-transitory computer readable medium that stores a program, wherein the program causes a computer to execute a control method for an electronic device, the method comprising:
an acquisition step of acquiring a captured image; and
a control step of performing control such that a plurality of captured images acquired in the acquisition step are arranged and displayed in order of image capturing in a plurality of image display regions, wherein
in a case where a delimiting image, which indicates a delimitation in order of image capturing, is included in the images acquired in the acquisition step, control is performed in the control step so as to display a display item, which indicates delimitation, in a region outside the plurality of image display regions, without displaying the delimiting image in the plurality of image display regions.
